(19) United States
(12) Patent Application Publication
(10) Pub. No.: US 2018/0088233 A1
(43) Pub. Date: Mar. 29, 2018

(54) FISHFINDER OF FLASHER TYPE

(71) Applicant: HONDA ELECTRONICS CO., LTD., Toyohashi (JP)

(72) Inventor: Shuichi SANO, Toyohashi (JP)

(73) Assignee: HONDA ELECTRONICS CO., LTD., Toyohashi (JP)

(21) Appl. No.: 15/276,255

(22) Filed: Sep. 26, 2016

(51) Int. Cl. G01S 15/96; G01S 7/60; H01Q 7/00; H04B 5/00

(52) U.S. Cl. CPC G01S 15/96; G01S 7/60; H04B 5/0037; H04B 5/0081; H01Q 7/00

(57) ABSTRACT

A fishfinder in which signal transmission is conducted between a reception antenna formed on a display rotation plate and a transmission antenna formed on a connection plate, both the reception antenna and the transmission antenna being opposed each other, and electric power transmission is conducted between a pair of inductive coupling coils, one being formed on the display rotation plate and the other being formed on the connection plate so as to oppose each other.

### BACKGROUND OF THE INVENTION

### 1. Field of the Invention

The present invention relates to a fishfinder of flasher type. In particular, the present invention relates to a fishfinder of flasher type through which vibration and noise can be removed in use and fishfinding operation can be stably conducted for a long time.

### 2. Description of the Related Art

A Display Window 31a is Disposed on a Front Case 31

Conventionally, it is proposed a fishfinder of flasher type as shown in FIGS. 1 and 2. In the fishfinder shown in FIGS. 1 and 2, a circular display plate 3 is arranged on a front case 1. A ring form window 2 is formed around all circumference of the circular display plate 3. A rotation plate 4 is arranged behind the circular display plate 3 and a light emission element 5 is disposed on the rotation plate 4 so as to oppose to the window 2. The rotation plate 4 is rotated by a motor 6. A slip ring 7 is fixed on a rotational shaft of the rotation plate 4 and a brush 8 is contacted to the slip ring 7. The brush 8 is electrically connected to an input device 9, thereby a display device 10 is constructed. Further, to the display device 10, a transmitter-receiver 11 is connected. When a signal is input from the transmitter-receiver 11, light emission power is input to the light emission element 5 through the brush 8 and the slip ring 7 from the input device 9. Therefore, as shown in FIG. 2, a portion A of the window 2 in the display device 10 becomes a starting point of light emission of the light emission element 5, the starting point indicating the sea surface. A portion B indicates school of fish. A portion C indicates a first reflection of sea bottom echo. A portion D indicates a second reflection of sea bottom echo.

However, in the above conventional fishfinder, since electric power and display signals are transmitted through the brush 8 and the slip ring 7, large vibration and noise are produced and the brush 8 is worn by friction and broken, thereby fishfinding operation cannot be stably conducted for a long time.

### SUMMARY OF THE INVENTION

The present invention has been made in taking above problems into consideration and has an object to provide a fishfinder in which electric power is supplied through a pair of a first inductive coupling coil and a second inductive coupling coil without use of the slip ring and the brush.

The present invention has another object to provide a fishfinder in which transmission and reception of various signals are conducted through a transmission antenna and a receiving antenna without use of the slip ring and the brush.

According to the above present invention, vibration and noise can be removed in use and fishfinding operation can be stably conducted for a long time.

In order to accomplish the above objects, according to one aspect of the present invention, it is provided a fishfinder of flasher type comprising:

a front case in which a transparent display window is formed;

a motor with a rotation shaft arranged on a main plate;

a display rotation plate fixed to the rotation shaft of the motor, the display rotation plate being disposed opposite to the display window;

a first inductive coupling coil formed around a rotation shaft part of the display rotation plate;

a second inductive coupling coil formed around a hole to insert the rotation shaft of the motor, the hole being formed in a connection plate;

a display LED fixed on the display rotation plate at a position opposite to the display window of the front case;

a reception antenna arranged on a circumference of the display rotation plate; and

a transmission antenna arranged on a circumference of the connection plate, the transmission antenna being opposite to the reception antenna on the display rotation plate.

### BRIEF DESCRIPTION OF THE DRAWINGS

FIG. 1 is a sectional view of the conventional fishfinder of flasher type;

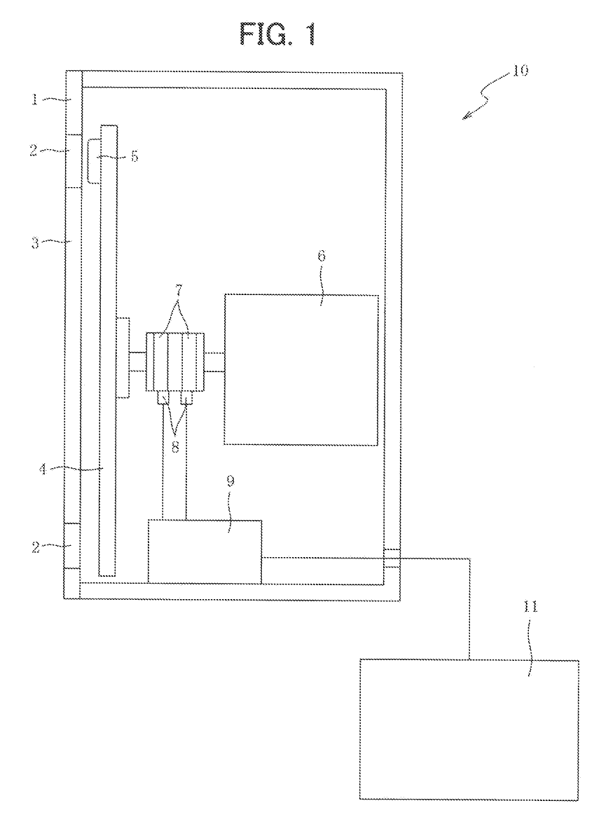

FIG. 2 is an explanatory view indicating a display portion of the fishfinder of flasher type shown in FIG. 1;

FIG. 3 is a block diagram of the embodiment of the fishfinder of flasher type according to the present invention;

FIG. 4 is an exploded perspective view of the fishfinder of flasher type shown in FIG. 3; and

FIG. 5 is a side sectional view of the fishfinder of flasher type shown in FIG. 3.

### DESCRIPTION OF THE PREFERRED EMBODIMENTS

A detailed description of a preferred embodiment of embodying the present invention will now be given referring to the accompanying drawings.

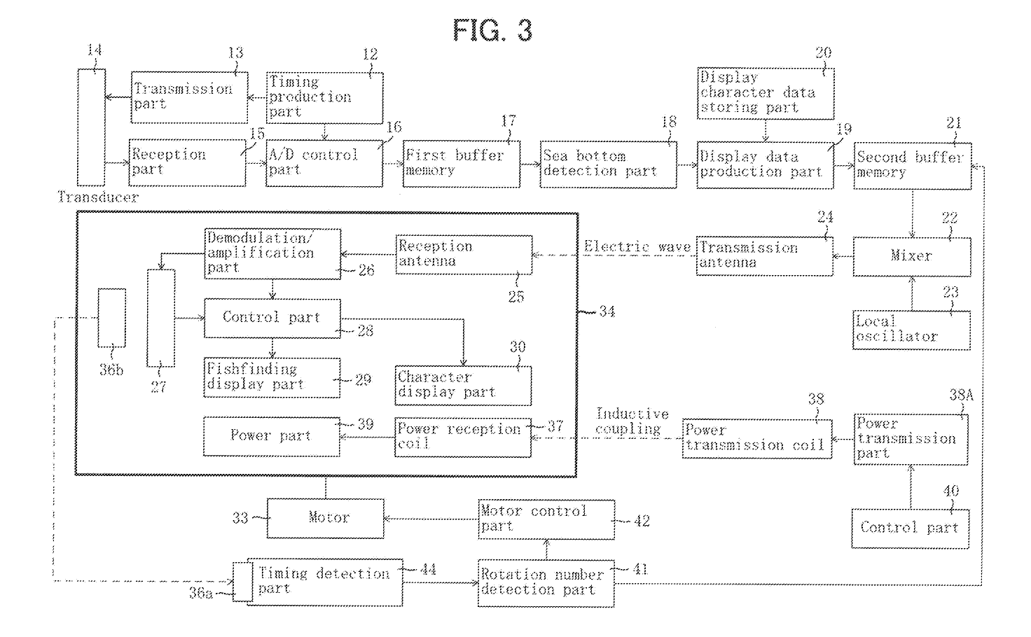

In the block diagram shown in FIG. 3, when a timing signal is transmitted from a timing production part 12 to a transmission part 13, an oscillation signal is output to an transducer 14. Thereby, ultrasonic wave is output in water from the transducer 14 arranged in water, and reflection signals reflected by objects, creatures and the bottom are sequentially input to a reception part 15. The reflection signals input to the reception part 15 are amplified and converted into digital signals in a AID control part 16. Such digital signals are temporarily stored in a first buffer memory 17.

The reflection signals read out from the first buffer memory 17 are input to a sea bottom detection part 18 and signals indicating the sea bottom are detected. All reflection signals including the sea bottom signals are input to a display data production part 19. Further, character data signals from a display character data storing part 20 are input to the display data production part 19 and the above signals are stored in a second buffer memory 21. The signals read out from the second buffer memory 21 are mixed with oscillation signals from a local oscillator 23 in a mixer 22. Such signals are sent out from a transmission antenna 24 for signal transmission, and received by a reception antenna 25 disposed on a display rotation disc plate 34 so as to oppose to the transmission antenna 24. The transmission antenna 24 and the reception antenna 25 are formed from metallic material. Signals received by the reception antenna 25 is demodulated and amplified in a demodulation/amplification part 26 and input to a control part 28. Fishfinding signals input to the control part 28 are input to a fishfinding display part 29 and character signals are input to a character display part 30.

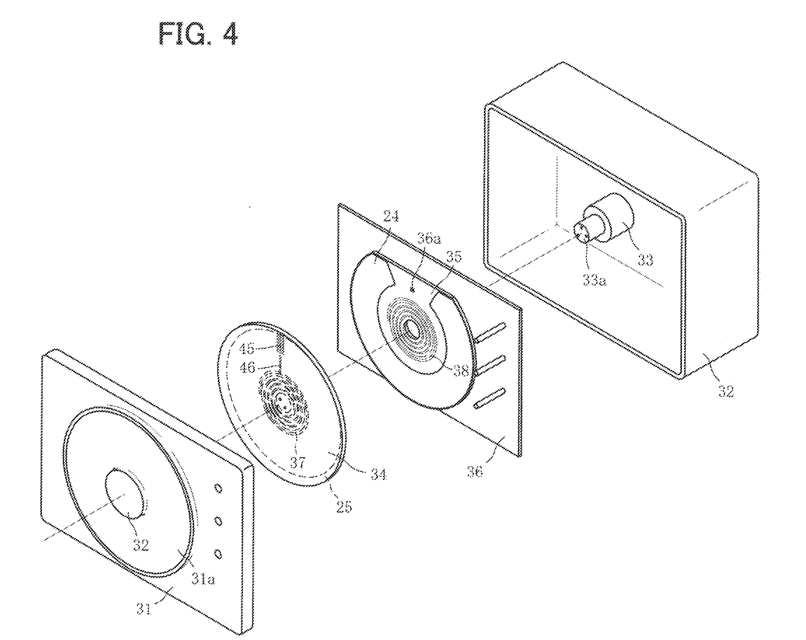

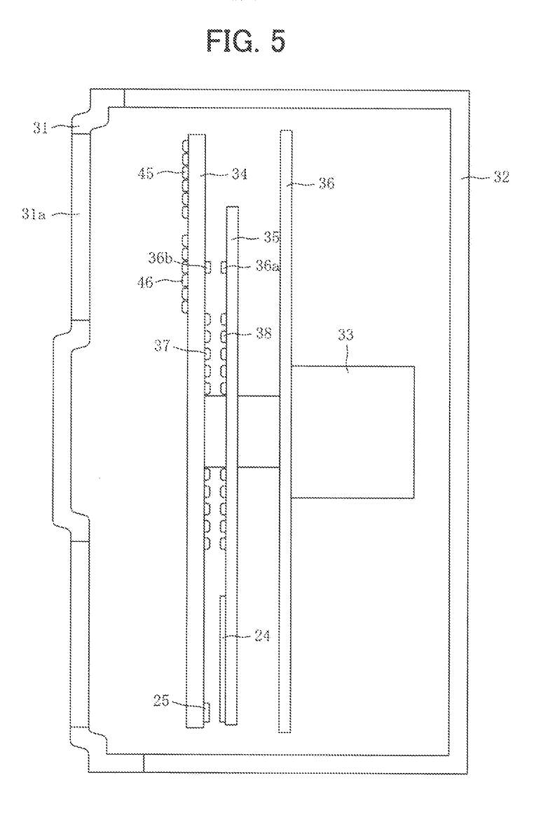

Further, as shown in FIGS. 4 and 5, a display window 31a is disposed on a front case 31. A display rotation circular disc 34 is fixed to a rotation shaft 33a of a motor 33 which is installed on a main plate 36. Such display rotation circular disc 34 is rotated by the motor 33. On the display rotation circular disc 34, the reception antenna 25 is formed around circumference thereof. Signals from the reception antenna 25 are input to the demodulation/amplification part 26 provided on the display rotation circular disc 34, and signals from the demodulation/amplification part 26 are input to the control part 28 provided on the display rotation circular disc 34. Further, signals from the control part 28 are input to both the fish finding display part 29 and the character display part 30.

Opposite to the display rotation circular disc 34, a connection plate 35 is formed together with a main plate 36. A power reception coil 37 is provided around a center of the display rotation circular disc 34. The power reception coil 37 supplies power to a power part 39 of the display rotation circular disc 34. The power part 39 supplies power to the control part 28, the fish finding display part 29 and the character display part 30. Such power reception coil 37 is arranged so as to oppose to a power transmission coil 38 disposed on the connection plate 35. The power transmission coil 38 is connected to a power transmission part 38A shown in FIG. 3. The power transmission part 38A is connected to a control part 40. Further, to the connection plate 35, a light reception element 36a constructing a timing detection part 44 is arranged and a light emission element 36b is arranged on the display rotation circular disc 34. Output of the light reception element 36a in the timing detection part 44 is detected by a rotation number detection part 41 shown in FIG. 3. A detection signal detected by the rotation number detection part 41 is input to a motor control part 42 and signals from the motor control part 42 are input to the motor 33. Rotation number of the motor 33 is controlled so that rotation number of the motor 33 equals to a predetermined rotation number. A LED 46 for displaying charters (see FIG. 5) is provided along a direction toward the center of a LED 45 for displaying provided on the display rotation circular disc 34.

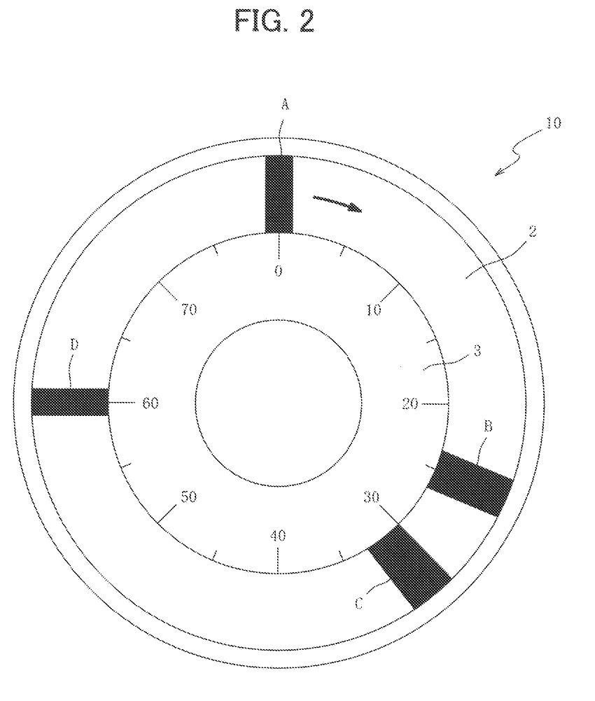

In the fishfinder according to the embodiment of the present invention, the ultrasonic reflection signals emitted from the transducer 14 in water are temporarily stored in the first buffer memory 17, thereafter read out therefrom and the sea bottom is detected in the sea bottom detection part 18. The reflection signals and the character data stored in the display character data storing part 20 are formed into the display data in the display data production part 19, the display data being stored in the second buffer memory 21. Such display data are read out from the second buffer memory 21, based on the timing signal from the light reception element 36a. The display data are transmitted from the light transmission antenna 24 of the connection plate 35 to the reception antenna 25 arranged along the circumference of the display rotation circular disc 34, thereby the signals corresponding to extent of strength in the reflection signals are demodulated and amplified in the demodulation/amplification part 26 and thereafter are input to the LED 45 arranged on the display rotation circular disc 34. As a result, as shown in FIG. 2, the oscillation line A is displayed in an upper part of the display window 31a in the front case 31, thereafter the echo B of school of fish is displayed, continuously the reflection of sea bottom (first reflection) C is displayed and finally the reflection of sea bottom (second reflection) D is displayed. Further, supply of electric power is conducted by the power transmission coil 38 and the power reception coil 37 and positional detection of the display rotation circular disc 34 is conducted by the light emission element 36b arranged on the display rotation circular disc 34 and the light reception element 36a arranged on the connection plate 35. Therefore, since contact members such as the brush and the slip ring to transmit signals and electric power are not provided, vibration and noise do not occur in use and fishfinding operation can be stably conducted for a long time as both the brush and the slip ring do not exist.

What is claimed is:

1. A fishfinder of flasher type comprising:
a front case in which a transparent display window is formed;
a motor with a rotation shaft arranged on a main plate;
a display rotation plate fixed to the rotation shaft of the motor, the display rotation plate being disposed opposite to the display window;
a first inductive coupling coil formed around a rotation shaft part of the display rotation plate;
a second inductive coupling coil formed around a hole to insert the rotation shaft of the motor, the hole being formed in a connection plate;
a display LED fixed on the display rotation plate at a position opposite to the display window of the front case;
a reception antenna arranged on a circumference of the display rotation plate; and
a transmission antenna arranged on a circumference of the connection plate, the transmission antenna being opposite to the reception antenna on the display rotation plate.

2. The fishfinder of flesher type according to claim 1, wherein both the transmission antenna and the reception antenna are formed from metallic material.

3. The fish finder of flasher type according to claim 1, further comprising a timing detection part,
wherein the timing detection part includes a light emission element fixed to the display rotation plate and a light reception element fixed to the connection plate, the light emission element and the light reception element being arranged so as to oppose each other.
